(19) United States
(12) Patent Application Publication
(10) Pub. No.: US 2020/0242229 A1
(43) Pub. Date: Jul. 30, 2020

(54) SYSTEM AND METHOD FOR BIOMETRIC ELECTRONIC VOTING

(71) Applicants: Brendan Curran, Myrtle Beach, SC (US); William Grosso, Myrtle Beach, SC (US)

(72) Inventors: Brendan Curran, Myrtle Beach, SC (US); William Grosso, Myrtle Beach, SC (US)

(21) Appl. No.: 16/657,839

(22) Filed: Oct. 18, 2019

Related U.S. Application Data
(60) Provisional application No. 62/797,537, filed on Jan. 28, 2019.

(51) Int. Cl. G06F 21/40; G06F 21/62; G07C 13/00

(52) U.S. Cl. CPC G06F 21/40; G07C 13/00; G06F 21/6209

(57) ABSTRACT

A system and method for electronic voting that allows for the real-time management of an election process across multiple localities on the local, city, county, state, and national levels, is disclosed. The electronic voting system and method comprises a multiprocessor and cloud-hosted software computer program stored on a computer readable storage medium for performing the steps of authenticating voter identification and eligibility to vote prior to providing a digital ballot for voting. Specifically, a PIN is created that is unique to the voter, which is then validated using multi-factor biometrics for voter authentication and for determining voter eligibility, thereby providing an extra layer of security for the voting process. An encrypted digital certificate is generated, which includes identification data including biometrics (fingerprint), and is supplied to an authentication body to identify the voter. Signed with an electronic signature by the voter, the encrypted the digital certificate is readable only by the authentication body. A voting message, including a vote, is generated and encrypted for reading by the counting body only. A signature block combining the digital certificate and the voting message is created and the encrypted digital certificate, the encrypted voting message and the signature block are sent to the authentication body.

### RELATED APPLICATIONS

This application claims priority to U.S. Provisional Application No. 62/797,537, filed Oct. 18, 2018, which is specifically incorporated herein by reference in its entirety.

### BACKGROUND OF THE INVENTION

The theory of voting began formally in the 18th century and since then many proposals for voting systems have been made. It is well known that the voting right is one of the basic principles of democracy guaranteeing involvement of citizens in political life at a country level and at national, regional and local levels and, therefore, the procedures used for voting preparation and implementation should be based on the principles of democratic elections and referenda.

There have been many studies on using electronic technologies to improve elections. When designing an electronic voting system, it is essential to consider all ways in which the voting tasks can be performed electronically without violating a voter's privacy or introducing an opportunity for fraud. An electronic voting system needs to define rules for a valid voting system that gives an efficient method of counting votes, which are finally aggregated to yield a final result. The ultimate end result of an electronic voting system is an improved voter identification process, elimination of voter fraud, and increased voter participation by utilizing biometric recognition.

The urgency of automation in the processes of operational and information support of the activity of organizational structures and citizens in preparation and implementation of various elections and referenda is obvious. Information and communication technologies are used more and more in everyday life, and are also used for involvement of the population in the process of preparation and implementation of elections and referenda including learning people on the legal basis of everyday life and their rights, measures on strengthening the democratic base of the voting systems.

When using the operational and information technologies for voting support and implementation, the voters should be provided with a possibility of voting not only at the polling place of their election district but also in other places and with other voting capabilities. In addition, maximum participation of all citizens having the voting right in elections should be supplemented with a possibility of participation in voting and referenda with an access to election process even if these are invalid voters and those who cannot be present physically at the polling place and to use the resources available. In so doing, efficiency and reliability should be provided during the transfer of the voting results, as well as, the information the course of preparation and implementation of voting, information the variants to be given to a voter for realization of his or her election including information on the candidates.

Voting should be secret and organized so that at any stage of the voting procedure, in particular, at a stage of establishment of the voter identity to eliminate everything that could break the secret of the voter's will. There are three main aspects to electronic voting:
1. The reliability of the count. This is the area where most of the cryptographic research has been focused. There are now available solutions, which achieve very high levels of cryptographic strength.
2. The possibility of error at the interfaces.
3. Remote authentication of the voters. Identifying and authenticating the voters is recognized as important, thus the use of biometrics, such as fingerprint identification.

The described method and system relate mainly to the interface between authentication and confidentiality, and the handling by an empowerment infrastructure of issues of identity and authentication.

The goals of an electronic voting system should be related to the reliability of the count, that is:
1. No one can vote more than once. Each voter having a unique serial number, which must accompany the vote, can achieve this. To prevent a counting organization from creating extra votes, the serial numbers are issued by a separate authentication agency.
2. No one should know for whom a particular person has voted.
3. No one can change a vote once cast. This can be achieved by including, with the vote, a cryptographic digest signed by the voter.
4. The public has confidence that voting data is not used for any purpose other than the election.
5. No one can duplicate another voter's vote.
6. No one can sell his or her vote.
7. A recount is possible in the event of a system crash. This means that voting messages, and enough ancillary information to make sense of them, must be taken offline. An advantage is that an audit, as well as a recount, becomes possible.
8. Only authorized voters may vote. Using the empowerment infrastructure, one
9. The Electoral Roll should be dematerialized. When everyone can establish his or her identity without it, the document itself is no longer needed.

The advantages of biometric voter identification of an individual's personally determined biometric characteristic(s) is/are included in a registration database are numerous, including:
Relatively precise identification (e.g. digital fingerprint identification alone is said to generally have an error rate less than 0.2%) without dependence on human inattention for whatever reason. A declared mismatch, if nothing else, should get the attention of a voting official to very carefully compare the observed characteristics of a voter compared to more common identification criteria such as signature and photo matching before allowing a disputed vote to be entered into the system;
Even without human intervention it gives assurance that the voter is a live counterpart of the one registered; and
Is much less, if at all, susceptible to counterfeiting as any token, such as a voting card, alone, or a password which may be entered by anyone who may have acquired it by theft or collusion with a legitimate voter by threats or effectively buying votes.

Voter identification is generally required during two phases of the electoral process: first for voter registration in order to establish the right to vote and afterwards, at voting time, to allow a citizen to exercise their right to vote by verifying if the person satisfies all the requirements needed to vote (authentication). In most countries this process of voter authentication and verification of identity is done manually, but some countries have implemented and others are experimenting with an automated or at least semi-automated method to verify the identity of voters and their right to vote. This implies the existence of an electronic voter register. In fact, the technologies used for voter identification at election time depend on the technologies used to establish the voter register.

Most recent voter identification technologies need to use digitalized voter information and may include the use of:
Flash Drives that record a person's personal information and biometric data
Database management systems where the digitalized data is stored and managed, on a regional basis

However, the technologies and voting methods described above are insufficient in adequately addressing the ever increasing needs for voter security and the accuracy and integrity of elections that currently exist. The present disclosure addresses problems associated with existing mechanical and electronic voting systems, including those mentioned above, and provides an increased level of security, confidence and economic advantage. For this reason, it is believed that the present invention constitutes progress in science and the useful arts, for which Letters Patent are hereby expressly requested.

### SUMMARY OF THE INVENTION

It is an object of this invention to provide a system and methods of electronic voting that addresses the insufficiencies in existing electronic voting systems. It is also an object of this invention to provide for the real-time management of an election process across multiple localities on the local, city, county, state and national levels. It is a further object of this invention to provide enhanced security of an election by providing multi factor biometric authentication and other requirements on more than one level.

Accordingly, disclosed herein is a multi-factor biometric electronic voting system and methods which, among other things, provide increased voting security for the authentication of individual voters and the tallying of their respective votes. The within invention requires a method and/or system for supplying data, a method to provide voter identification and authentication using biometrics and a voter PIN, a digital signature and digital certificates, a method and/or system for electronic voting.

According to previous information provided, there is a system in place for electronic voting in which there is an authentication body, a counting body, and a plurality of voters; the system comprises the use of a digital certificate generated by a voter, the digital certificate includes identification data which is to be supplied to the authentication body to identify the voter uniquely and the digital certificate includes the identification data itself, the digital certificate being signed with an electronic signature by the voter such as a fingerprint (biometrics); the digital certificate being encrypted for reading by the authentication body only; a voting message including a vote generated by the voter; the voting message being encrypted for reading by the counting body only; and a signature block combining the digital certificate and the voting message; wherein the encrypted digital certificate, the encrypted voting message and the signature block are sent to the authentication body.

The identification data may include one or more of: name, address, date of birth, nationality, length of residence, and non-membership of prohibited classes of the voter. The authentication body may issue a serial number for the voter. The authentication body may construct a message including: the voter's serial number, a digest of the digital certificate, the message being encrypted by the authentication body. The authentication body to the counting body may send the message, the encrypted voting message and the signature block.

There is provided a computer program product stored on a computer readable storage medium comprising computer readable program code means for performing the steps of: generating a digital certificate, the digital certificate includes an indication of identification data which is to be supplied to the authentication body to identify a voter by the digital certificate and includes the identification data itself, fingerprint (biometrics). The digital certificate also includes an indication of a voting key; signing the digital certificate with an electronic signature by the voter; encrypting the digital certificate for reading by the authentication body only; generating a voting message including a vote; encrypting the voting message for reading by the counting body only; generating a signature block combining the digital certificate and the voting message; sending the encrypted digital certificate, the encrypted voting message and the signature block to the authentication body.

Biometrics is an essential component of personal identification solutions from time clocks, safes, computer logins, employee identification, home and car entry, etc. Biometric identifiers cannot be shared or misplaced; they represent each individual's identity. Biometric recognition refers to the use of iris, fingerprint, face, palm and speech characteristics, all are called biometric identifiers. Fingerprint matching is the significant part of this process in our electronic voting system.

### BRIEF DESCRIPTION OF THE DRAWINGS

The above-mentioned features and objects of the invention will become more apparent with reference to the following description taken in conjunction with the accompanying figures. The figures illustrate ways of implementing the present invention and are not to be construed as being limiting to other possible embodiments falling within the scope of the attached claims.

FIG. 1 is an overview of the within method illustrating a pathway of steps by which a voter accesses the system through a PIN and activates a digital ballot after biometric registration and authentication;

FIG. 2 is a flow diagram of the PIN validation process to verify the eligibility of the voter and prevent ineligible voters from voting;

FIG. 3 is a flow diagram of the process for generating an appropriate ballot; and

FIG. 4 is a flow diagram for generating a vote.

### DETAILED DESCRIPTION OF THE INVENTION

The system and methods according to the invention will now be described in more detail with regard to the accompanying figures.

The present inventors have realized that general purpose processors and computers, such as laptop computers, tablet computers (with touch screens) and the like, together with multi-level security provided by multiple biometric authentication, can be used to address and overcome many of the existing problems with voting systems. The present inventors have realized a series of improvements over conventional voting systems that shall substantially bolster public confidence, while adding reliability and economic efficiencies. The system and method of this invention comprises a new cloud based platform that streamlines and enables individuals to vote in almost any way without having to go to voting locations. It unifies the process and saves local/state/federal potentially billions of dollars by simplifying and opening up more secure access to the voting process.

Each electronic voting system comprises a general purpose computer (e.g., a personal computer) or processor as a hardware platform onto which is installed a software platform including voting software. The personal or general purpose computer can be any type of computer including, without limitation, a laptop computer, a tablet computer, a desktop computer or a mobile device. The electronic voting system can use any type of input/output device, including a touch screen, digitized tablet or pad, pressure-sensitive pad, mouse, keyboard, keypad, scanning device, printer, Braille terminal, etc. In accordance with one or more embodiments, additional hardware and/or software can provide the capability to accommodate a voter's special needs (e.g., hearing, eyesight, etc.) be they physical, mental or otherwise.

Embodiments of the within invention utilize a multiprocessor and cloud-hosted software system such that the cloud hosted software configures the multiprocessor to access the cloud, which serves as a base for data storage. In addition the cloud hosted software configures the multiprocessor to perform the stepwise tasks required by the voting method, including identification of the voter, voter eligibility, authentication of the voting procedure requested by the voter, generation of the requested ballot and accomplishing the task of voting, recording the vote and securing the results.

Accordingly, disclosed herein is an electronic voting system and method for electronic voting provided for using a cloud hosted platform. The electronic voting system is comprised of a cloud hosted software system that allows for management of the election process across multiple localities. Integrating high-volume common tasks associated with an overall process can be accomplished in an efficient and cost-effective manner. The cloud hosted platform also provides backend processing for different front-end configurations.

In addition, the cloud based software performs and integrates components of the election process including setting up ballots and presentation, a voter's registration, validation of the voter, on-line voting, a real time vote count, and results tracking. The vote totals are captured at multiple and detailed demographic levels.

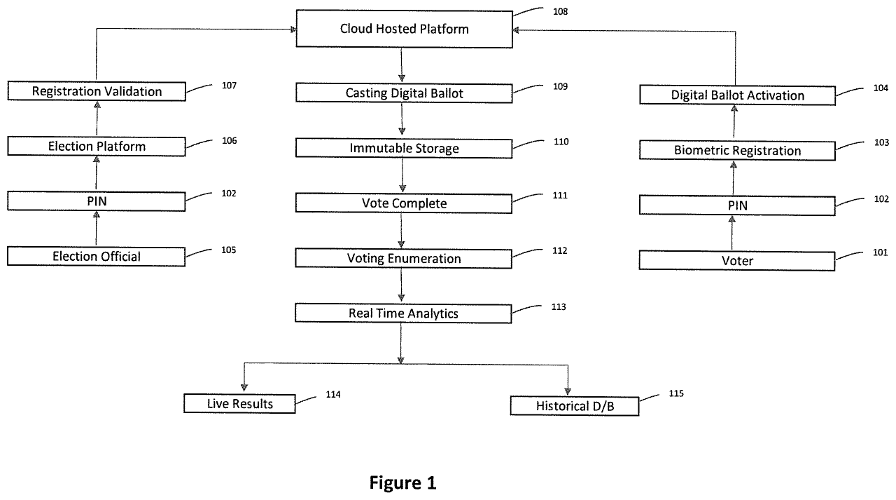

FIGS. 1-4 provide a non-limiting and merely illustrative example of a multi-factor biometric electronic voting process flow for use with one or more embodiments disclosed herein. In accordance with the invention, an election official 105 enters information pertaining to a particular election into the cloud hosted software system in cloud hosted platform 108 using an election interface. The election information includes, for example, the identification, name and/or description of the particular election(s) being run by the official, such as, for example, a primary election, mi-term election, and/or presidential election. The election can be local, statewide or nationwide also. Other election information includes election starting and ending dates and times, localities included in the election, and/or other desired descriptive information. This information is entered into the cloud hosted software system and stored in an election data base 301 on an election platform 106, to be accessed by the multiprocessor configured by the cloud based software. The meaning of an election is a grouping of one or more races scheduled to run within a predefined timeframe.

For the purposes of this invention, an election race is defined by information entered onto the cloud hosted software system through a candidate assignment interfaced by the election official. Race information includes for example, the race name, race description, type of race, assigned candidates, localities where the race is being run, registered candidates, referendums, propositions, questions, the election in which the race is included, and/or other descriptive information. This information allows a race and candidate to be assigned to a particular election.

After electoral jurisdictions, political party and party attributes, registered candidates, referendum and propositions, election and candidate assignment information are entered into the cloud hosted software system, the appropriate data bases are established. The information in the data bases is consolidated by the cloud hosted software system in a pre-election batch or on-line process and sent to a cloud based software system, where the data bases are created to support ballot presentation to voters. The cloud based software system, configures information from a ballot presentation data base 303 for presentation to the voter on a ballot presentation interface. The ballot presentation data base is keyed and sorted using information such as, election, country or highest-level locality, state or province, and/or precinct or lowest level locality. In elections such as primary elections, the ballot presentation data base 303 can also be keyed and sorted by political party and for each precinct. The ballot presentation data base 303 contains information such as, valid jurisdictions, races, candidates, party affiliation of each candidate, referendums, propositions, and/or any other desired information, for presentation to the voter.

The cloud based software system further includes a database containing graphical content and/or information that is uploaded for the ballot presentation to the voters. A system administrator can enter information on locality specific content for ballot presentation through an interface with the cloud based software system, creating ballot presentation content data base 303. The information can be made specific to any locality by the election official. The cloud based software system combines the graphical content with the consolidated information in the ballot presentation data base and the appropriate ballot presented to the voter.

Once voter eligibility and authentication is confirmed, as described below, the electronic voting system is ready for voter access and voting can begin. Voter access is accomplished using biometrics registration 103 (fingerprint identification) and security protocols (digital certificate) to establish authentication. The cloud based software system, retrieves the appropriate ballot information using voter information retrieved from the registered voter data base 402, graphical content and information data base, and the ballot presentation data base 302. This action results in presenting an appropriate ballot to the voter.

After the voter enters and confirms their choices, the votes are recorded in an election result data base that captures the voting results and demographic information of the voter without specifically identifying the particular voter. Simultaneously, a record is added to the registered voter data base indicating whether a particular voter has voted or not and prevents that voter from voting a second time. The information in the election result data base is used to determine the official results of the election and for tracking real-time election results. The election result data base also stores an encrypted version of each voter's ID that could then be used to support any disputes involving the vote or election process.

In addition, the system and method of the within invention include a data base containing a list of eligible voters. This database contains names and information of people nationwide that are eligible and/or ineligible to register to vote. Defined user groups 201, such as a Federal, State, or Local Government Agency 204 or Official and/or a Law Enforcement Entity 203, dependent upon the particular election being run, would define eligibility or ineligibility. The user groups 202, 203, 204, 205 would perform their own internal analysis using, for example, Social Security records, death records, criminal records, and/or other identifying records to create and update these data bases. Prior to any election, the data bases are transmitted to the cloud hosted software system and updated periodically. The cloud hosted software system evaluates each registering voter against internal data bases to determine that a person is either eligible or ineligible to vote. If the registering voter is deemed ineligible, the registration is rejected, and a record for the registration attempt is sent to a rejected voter registration data base. Additionally, one or more of the user groups noted above may send a registration attempt that is rejected to a queue that is manually worked.

In an embodiment of this invention, a registering voter 101 may request a registration form from a voter registrar. The voter registrar can either print the requested form or have pre-printed forms available with predefined questions and rules found in a registration question pick list data base and registration screen content and form layout rules data base that are appropriate for the locality and election in question. The registering voter 101 or voter registrar enters registration data via an on-line voter registration interface and the questions and rules content taken from the registration question pick list data base and registration screen content and form layout rules data base. The registration data is then be evaluated against the eligible voter data base. Successful registrations are loaded to a registered voter database on the cloud hosted software system along with all demographic and other information captured from the registering voter answers to the registration questions.

The registered voter database contains records of eligible voters and assigns unique voter identification for each voter. The unique voter identification serves as a key for all internal tables or data bases that ties the registered voter to a country, state, province, locality, precinct, address, and/or demographic profile including, for example, the voter's name, address, and any other desired demographic information. Based on the voter information stored in the registered voter database the voter's precinct can be determined based, for example, the unique voter identification assigned to the voter, and/or through a ZIP code, street address or combination thereof.

A real-time process transfers the information to the cloud hosted software system and ties the voting information that is on the voting record to a voter's general demographic profile. Once the voting record is real-time linked to the cloud hosted software system the information that ties a vote to a specific voter is deleted and not stored on any of the result log data bases. Therefore, at no time during the election process will an individual, i.e., system administrator, election official, and voter registrar, be able to tell who a specific voter voted for. However, the information sent to the cloud hosted software system that ties a vote to a voter is stored in memory to identify a general demographic profile.

Turning now to the drawings, FIGS. 1 to 4, those skilled in the art will understand steps that can be substituted for that which are illustrated. These figures show how, in accordance with one or ore disclosed embodiments, a voter is authenticated prior to casting his vote, in order to determine the authenticity and eligibility of the voter. Multi-factor biometric information of the voter will be compared to data in an independent database recording the identity of voters, and a PIN is generated. Thus, FIG. 1 is an overview of one embodiment of how the multi-factor biometric electronic voting method of the invention occurs. The method is based on the registration of two entities for the process: an election official 105 and a voter 101. From both entities, data is processed with the system software through the multiprocessor and stored in the appropriate categories on the mainframe in two main files: the ballot file and the voter file. Voter 101 begins by accessing PIN 102, where the validation process begins with multi-factor biometric registration 103, which includes any combination of known and unknown advanced technologies, for example: finger print, voice print IRIS scan, etc. Once successfully validated a digital ballot 104 is activated. Election official 105 also accesses PIN 102 to validate identity and eligibility to gain access to the election platform 106, where election information resides including election meta data, death records, felony records etc. From this information voter's 101 registration is validated 107.

The voter's registration validation 107 information connects to the cloud hosted platform 108 where it links to the voter's biometric registration 108 data and successfully registers and validates the voter and generates a voter ID and activates digital ballot 104. From that combined information digital ballot 109 is cast. Once cast digital ballot 109 is saved in an immutable storage 110 area where it is not capable of or susceptible to change. The vote has now been completed 111 and moves on to voting enumeration 112 where the vote is counted.

Voter 101 then accesses the cloud hosted platform 108 through the use of biometric registration 103 at any location where there is an Internet connection. The voter identification number initiates a message to the voter file and cloud hosted platform 108. This initiates a message to the ballot database 305, where the voter identification number generates a ballot and is sent to the multiprocessor. At the same time the voter file is also sent through the multiprocessor and the two are linked, thus, producing the voting ballot to the voter.

Once the voting ballot is received at any location where an Internet connection and viewing screen is accessible, the voter will proceed to cast their vote. Once the vote has been cast, this information will be sent through the multiprocessor and on to the cloud hosted platform 108 for two main storage files: vote file and voter verification file. Voter verification file registers the voter so there is no possibility of voting a second time and records the necessary information if there is a future dispute without revealing the voter.

Vote file then processes the information for the main purpose of tabulating the election results. However, during the election process this information will give real time voting and results tracking 113, 114. The other purpose of vote file is to register the vote in a historical file 115, so that in the future if there is any dispute the results can be verified without revealing the identity of the voter.

PIN 102 provides a second level of security over multi-factor biometric registration 103. PIN 102 provides a network platform that identity information routes through during the process of authentication and validation. It provides for an open set of API endpoints for both the providers and clients of the authentication and validation process. PIN 102 is openly integratable with any devices or services that can produce a digital signature for use in this invention. PIN 102 involves multiple factor authentication and portable secure tokenization of voter's 101 identity to guarantee identification and allow for transparent access to authorized information as well as action voter 101 can take in a particular environment.

The method can be applied by any combination of known and unknown biometric measuring systems as input for encryption key generation. Each input is serialized and combined in N! combination of encrypted messages.

PIN 102 method connects identity providers and application providers in a secure platform where only the users of the platform can see their own messages and data. Certain elements of that data can be unlocked for the purposes of the application. In the election case the voting object would expose the candidate voted for while keeping identity of the user who voted secure and locked in an immutable storage object. From both entities, data is processed in the cloud hosted platform 108 and stored in appropriate data bases on the cloud based software system platform: ballot data base 305 and voter data base.

Voter 101 then accesses the the system of the within invention through cloud hosted platform 108 using biometric identification at any location where there is an Internet connection. A voter identification number initiates a message to the voter data base and cloud hosted software system 108. This initiates a message to the ballot data base, where the voter identification number generates a ballot and is sent to cloud based software system 108. At the same time the voter data base is also sent through cloud based software system 108 and the two are linked, thus, producing the voting ballot to the voter.

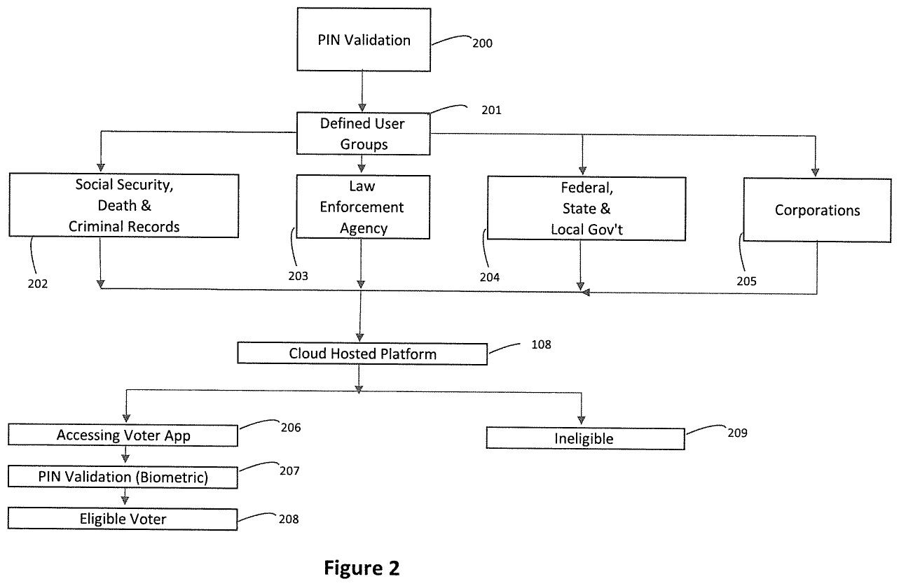

FIG. 2 is an overview of the voter registration process to verify the eligibility of the voter and prevent ineligible voters from voting. Data gathered from the registration validation 107 of the potential voter is combined with the data from the biometric registration 103 of that same potential voter and this data is verified and compiled in the cloud hosted platform 108. This voter data is then screened against innumerable data bases in the cloud hosted platform 108. It is through this voter registration process that the multi factor biometrics (finger print identification, voice print, etc.) are established, thus, enabling voter 101 to vote from their mobile device (smart phone, tablet, laptop, desktop or kiosk at any location where there is an Internet connection. The voter will enter the necessary information in a normal voting registration process. At the same time, the voter will enter the fingerprint identification (left index, right thumb, etc.) of their choice for future login and voting. In the case of voters that are already registered, their data bases will need to be updated with their biometric identification for future voting. This information is what is used to assign an internal voter identification number so the appropriate ballot is presented to them for voting.

In the process, the voter registration information will be processed through three main user groups 201 for eligibility to vote: (1) social security 202 to confirm the voter exists, death records to show the voter is still eligible to vote, and finally, criminal records to determine if a voter is ineligible to vote; (2) Law Enforcement Agencies 203 to determine if a voter is eligible to vote, even though the voter might have an social security number that voter could possibly be an illegal alien that is not entitled to vote; (3) Federal, State, and Local governments 204 to determine there are no other factors that would make a voter ineligible to vote by law.

Once this process has been completed the information will be sent through the cloud hosted platform 108 to: the eligible voter data base or ineligible voter data base Each time there is a vote to take place; this process will be completed on all voters to confirm their eligibility to vote.

If the information goes to ineligible voter data base this information will be passed on to the appropriate user groups as to why they were declared ineligible. Voter 101 will have the ability in this case to see why they were determined ineligible and contact the appropriate user group to have their information verified or recanted so they can be placed in the eligible voter data base.

If the voter goes to the voter eligible data base, then the biometric information will be registered for faster and easier access to their data base in the future. This multi factor biometric identification will also let them access their file in the future if certain information needs to be updated in regards to their eligibility to vote and other information such as their address that helps generated their appropriate digital certificate that is used to generate their internal voter identification number so they receive the appropriate ballot for voting.

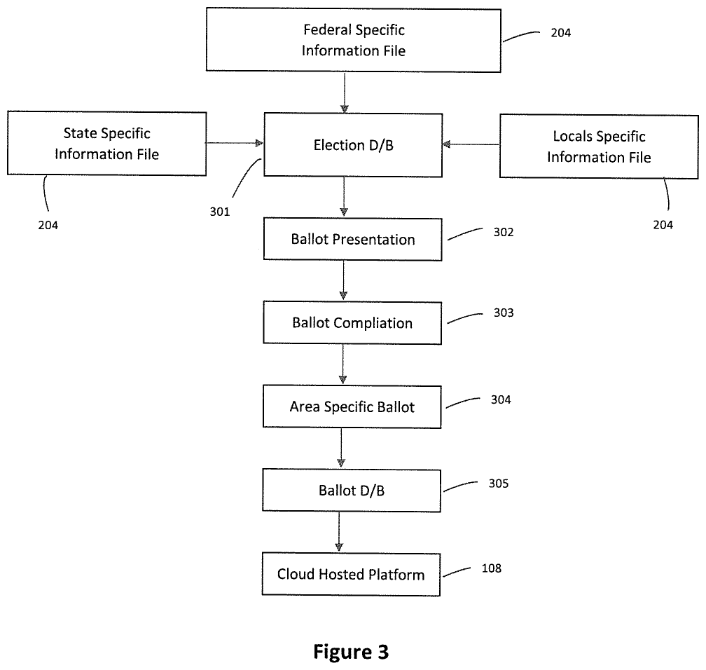

FIG. 3 is an overview of the process of how an appropriate ballot is generated. In this case biometrics (fingerprint identification) will be used to identify those election officials that will be entering the appropriate information into the system for purpose of creating the appropriate ballot based on the internal voter identification number.

There are three main entities for entering the appropriate information into the system for the generation of ballots. If needed, this can be further broken down depending on the structure of the area of voting. Information is gathered from the federal specific information file 204 which contains the candidates running for federal office, and the state specific information file 204 which contains the candidates running for state office and the local specific information file 204 which contains candidates running at the local office. This data is compiled in the cloud hosted platform 108.

Data is then sent to election database 301 for ballot compilation 303 which then creates a ballot and then that information is matched to the voter ID to create an area specific ballot 304.

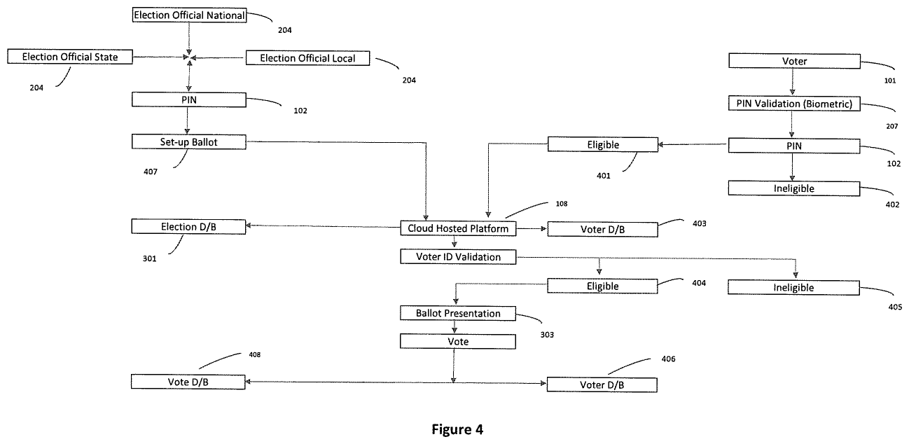

FIG. 4 is a flow diagram for generating a vote in accordance with an embodiment of the within invention and illustrates both sides of the election platform and both audiences. On the left side in FIG. 4 are the election entities 204, and on the right side is voter 101. The embodiment shown in FIG. 4 is that of a mobile voting platform only, which is novel in view of any prior art.

In this embodiment, both election official entities 204 and voter 101 go through a two-step authentication process. Election official entities 204 are validated through PIN 102 network which authenticates their identity as being valid. Voter 101 who is using an App on a mobile device, such as a cell phone or laptop, does a biometric PIN authentication 207 as a self-authentication process. The PIN network 102 is that relationship and that validation of identity so you are who you are, and those things are passed ultimately to cloud hosted platform 108. So once election officials 204 and voter 101 are authenticated via PIN network 102 they flow into cloud hosted platform 108 which is the election platform of the within invention. The election platform of this embodiment comprises election database 301 and the ballot setup information 407, content, data that go with that and the voter and registration database that goes as part of the platform as well. Voter database 408 also references official federal, state and local databases and services to validate that voters are registered voters and valid voters. Once voter 101 is authenticated he is proceeding to being eligible 401. Similarly, once election officials 204 are validated, the parties are joined and are willing to exchange a certain subset of personal information through the cloud hosted platform services. Now once both parties are in there is a voter ID validation and the voter ID validation is a process that checks two things to determine voter eligibility, voter 101 is either eligible 404 or ineligible 405. There are two main checks, one that is linked to and identified in the voter database as being a valid registered voter, and one that determines whether you have not already casted a ballot. If both of those are true voter 101 is eligible 401, and if either one is false voter 101 is ineligible 409. If voter 101 is eligible, the process moves to ballot presentation 303. Which the presentment of the digital ballot on the mobile device. This enables voter 101 to select and vote on their candidates. Then, the voting information is divided into two different areas of the platform. Voter database 408 stores and enumerates the votes and doesn't contain personal information other than the votes for the candidates themselves. On the other hand, the voter database 406 collects the existence of the vote and the ballot being made and checked off the voter database. It will be recognized whether steps 404 and 405 are properly checked if the voter were to come back and attempt to vote again.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation as to encompass all such modifications and similar structures. Thus, the present disclosure includes any and all embodiments of the following claims.

1. A secure multi-factor electronic authentication and voting system comprising, in combination:
a cloud hosted platform having a cloud based software system;
at least one processor;
at least one computer readable storage medium bearing instructions which when executed by the processor configure the processor for;
receiving and storing registration data from an election official;
establishing a personal identity network that is unique to a voter by receiving unique authentication information from said voter and storing said voter unique authentication information in a database in said personal identity network on said cloud hosted platform;
in response to a voting request by a voter in an election, authenticating the identity of said voter by accessing said personal identity network unique to said voter, entering contemporaneous authenticating data from said voter and comparing said contemporaneous authenticating data to said voter's unique authentication information in said personal identity network established by said voter;
validating the identity of said voter by said election official based on said voter unique authentication information in said personal identity network;
activating a digital ballot once said voter is authenticated and validated;
presenting said digital ballot to said voter, enabling said voter to cast said ballot;
recording said vote cast by said voter; and
generating an encrypted voting message to be sent to an election body counting said vote.

2. The electronic authentication and voting system of claim 1, wherein said unique authentication information received from said voter is biometric information, and said contemporaneous authenticating data is biometric data.

3. The electronic authentication and voting system of claim 2, wherein said biometric information and said biometric data comprise finger prints, palm prints, facial patterns, eye scans and/or hand measurements.

4. The electronic authentication and voting system of claim 1, further comprising issuing a voter identification number unique to said voter and storing said voter identification number on said processor.

5. The electronic authentication and voting system of claim 2, further comprising a mobile electronic device, and wherein said digital ballot is presented to said voter on said mobile electronic device.

6. A method for secure multi-factor electronic authentication and voting, comprising the steps of:
in a cloud hosted platform comprising a cloud based software system, at least one processor and at least one computer readable storage medium;
receiving and storing registration data from an election official;
establishing a personal identity network that is unique to a voter by receiving unique authentication information from said voter and storing said voter's unique authentication information in a database in said personal identity network on said cloud hosted platform;
in response to a voting request by a voter in an election, authenticating the identity of said voter by accessing said personal identity network unique to said voter, entering contemporaneous authenticating data from said voter and comparing said contemporaneous authenticating data to said voter's unique authentication information in said personal identity network established by said voter;
validating the identity of said voter by said election official based on said voter's unique authentication information in said personal identity network;
activating a digital ballot once said voter is authenticated and validated;
presenting said digital ballot to said voter, enabling said voter to cast said ballot;
recording said vote cast by said voter; and
generating an encrypted voting message to be sent to an election body counting said vote.

7. The method of claim 6, wherein said unique authentication information from said voter is biometric information, and said contemporaneous authenticating data is biometric data.

8. The method of claim 7, wherein said biometric information and said biometric data comprise finger prints, palm prints, facial patterns, eye scans and/or hand measurements.

9. The method of claim 6, further comprising issuing a voter identification number unique to said voter and storing said voter identification number on said processor.

10. The of claim 6, further comprising the step of presenting said digital ballot to said voter on a mobile electronic device.
